(19) United States
(12) Patent Application Publication
(10) Pub. No.: US 2010/0147030 A1
(43) Pub. Date: Jun. 17, 2010

(54) METHOD AND APPARATUS FOR FORMING A DOUBLE-CURVED PANEL FROM A FLAT PANEL

(75) Inventors: Daan Rietbergen, Delft (NL); Karel Jan Vollers, Amsterdam (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 12/633,055

(22) Filed: Dec. 8, 2009

Related U.S. Application Data
(63) Continuation of application No. PCT/NL2008/050243, filed on Apr. 24, 2008.

(30) Foreign Application Priority Data
Jun. 12, 2007 (NL) 2000699

(51) Int. Cl. C03B 23/023

(52) U.S. Cl. 65/106

(57) ABSTRACT

A method for forming a double-curved panel from a flat panel, which comprises processing a plastically deformable flat panel or rendering the flat panel plastically deformable to enable it to mould itself to a predetermined shape, wherein the shape is obtained by a primary supporting construction cooperating with a secondary supporting construction, wherein the primary supporting construction may or may not be adjustable to an invariant position that determines the shape, and the secondary supporting construction is adjustable between a starting position in which it supports the flat panel, and a finishing position in which the secondary supporting construction supports the double-curved panel, while said supporting construction rests on and is shaped in accordance with the shape of the primary supporting construction, wherein the adjustment from the starting position to the finishing position occurs at least subject to the distribution of the gravitational force exerted on the secondary supporting construction by the panel while this is plastically deformable.

### CROSS-REFERENCE TO RELATED APPLICATIONS

This application is a continuation application of International Patent Cooperation Treaty (PCT) Application Serial No. PCT/NL2008/050243, entitled “A Method and Apparatus for Forming a Double-Curved Panel from a Flat Panel”, to Technische Universiteit Delft, filed on Apr. 24, 2008, which is a continuation application of Netherlands Patent Application Serial No. NL 2000699, to Technische Universiteit Delft, filed on Jun. 12, 2007, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention

In the first place the invention relates to a method for forming a double-curved panel from a flat panel, which comprises processing a plastically deformable flat panel or rendering the flat panel plastically deformable to enable it to mould itself to a predetermined shape.

2. Description of Related Art

From the European patent publication EP-A-O 440 884 a method is known for forming a single-curved glass panel from a flat glass panel, wherein after heating, the flat glass panel moulds itself to a plurality of curved rods that support the glass panel. Heating provides the glass panel with the desired plastic deformability.

The method known from the European patent publication EP-A-O 440 884 is not suitable for forming a double-curved glass panel.

It should be noted, that the invention may be employed with glass panels, but also with panels made of a different material such as, for example, plastic, a composite material or metal, or any other material that might be intended now or in the future to be subjected to the deformation process referred to herein.

In order to provide a method for forming a double-curved glass panel, it is usual practice to use moulds that have been shaped in accordance with the shape eventually desired for the glass panel. As the glass panel before it has molded itself to the mould starts out flat, the manufacture of the double-curved glass panel involves particular problems, with breakage being a frequent occurrence. In practice it happens regularly that a pane has to be made anew up to ten times before the resulting double-curved glass panel is acceptable.

### BRIEF SUMMARY OF THE INVENTION

One of the objects of the invention is to provide a reliable method for forming a double-curved panel from a flat panel, and by which the desired double-curved panel can be made available at lower costs than is the case with the prior art technique.

To this end the method according to the invention is characterized by one or several of the appended method claims

### DESCRIPTION OF THE INVENTION

In a first aspect of the invention, the method for forming a double-curved panel from a flat panel is characterized in that the shape is obtained by a primary supporting construction cooperating with a secondary supporting construction, wherein the primary supporting construction may or may not be adjustable to a fixed position that determines the shape, and the secondary supporting construction is adjustable between a starting position in which it supports the flat panel, and a finishing position in which the secondary supporting construction supports the double-curved panel, while said supporting construction rests on the primary supporting construction and is shaped in accordance with the shape of the primary supporting construction, wherein the adjustment from the starting position to the finishing position occurs at least subject to the distribution of the gravitational force exerted on the secondary supporting construction by the panel while this is plastically deformable. If desired, the adjustment of the secondary supporting construction may be aided in another way, for example, by additional pressure means, or by providing a partial vacuum under the panel being supported by the secondary supporting construction.

When the finishing position is reached, the plastic deformability of the panel may be terminated or reduced by a suitable process. This process may involve, for example, terminating the heating at a glass panel, or fixing a flexible plastic panel by means of UV radiation. However, which process and which material is used is of minor importance as long as the essence of the invention, being embodied in the cooperation between the primary supporting construction and the secondary supporting construction, is employed.

The method proposed according to the invention facilitates an efficient production method for shaping the double-curved panel and making a mould, as in the prior art, becomes superfluous while less glass is being used in the manufacture of a double-curved glass panel because glass breakage is significantly reduced.

The invention is also embodied in an apparatus with which this production method for forming a double-curved panel from a flat panel can be executed effectively.

To this end the apparatus according to the invention is characterized by one or several of the appended apparatus claims.

In a further aspect of the invention, the apparatus is therefore characterized in that it comprises a primary supporting construction that may or may not be adjustable to a time-invariable form that corresponds to a desirable double curve of the panel, as well as a secondary supporting construction that is designed to rest on the primary supporting construction and, subject to a distribution of gravitational force from a panel resting on the secondary supporting construction, is deformable into a shape that corresponds to the time-invariable shape of the primary supporting construction.

The effectiveness and the simple realization of the desired double-curved shape is obtained in particular by the fact that the primary supporting construction and the secondary supporting construction define cross-wise intersecting supporting lines.

The above described starting points provide a basis for various ways in which to realize both the method and the apparatus in a simple and suitable manner.

In a first embodiment, the primary supporting construction may be provided with a plurality of additional construction elements, which at the upper side define a plurality of first supporting lines, and that all of these first supporting lines determined by the construction elements lie in an imaginary plane having the predetermined shape.

This primary supporting construction is then formed, for example, by a number of steel plates manufactured manually or computer-controlled, which are placed at some distance from each other and together fulfill a supporting function for the secondary supporting construction described above.

The secondary supporting construction in turn is then preferably formed like a mat comprised of a plurality of flexible rods disposed next to each other. These rods are kept at a distance from each other, for example, by coupling them to each other or by lodging each rod in grooves provided at the top side of the primary supporting construction. This mat of flexible rods has to be constructed such as to allow the rods to readily deform under the influence of the thermo-plastically deformable panel resting on the secondary supporting construction, allowing the same to shape itself to the desired double-curved shape.

In order to be able to assume the desired double-curved shape embodied in the construction elements of the primary supporting construction, it is desirable for the plurality of flexible rods of the secondary supporting construction to be placed cross-wise (preferably orthogonally) on the plurality of first bearing lines of the construction elements of the primary supporting construction, which rods thus form a plurality of second bearing lines, which serve to support the panel.

The invention, whose essence is embodied in the appended claims, will be further elucidated below, with reference to the drawing.

### BRIEF DESCRIPTION OF THE SEVERAL VIEWS OF THE DRAWINGS

The drawing shows in:

FIG. 1, a primary supporting construction as can be used with the method according to the invention;

FIG. 2, the primary supporting construction according to FIG. 1, above which is placed a secondary supporting construction in a starting position, supporting a flat glass plate,

FIG. 3, the primary supporting construction and the secondary supporting construction with the glass plate resting thereon, while these have been moved to the finishing position, and

FIG. 4, the apparatus shown in FIG. 3, wherein the glass plate is shown to be transparent.

### DETAILED DESCRIPTION OF THE INVENTION

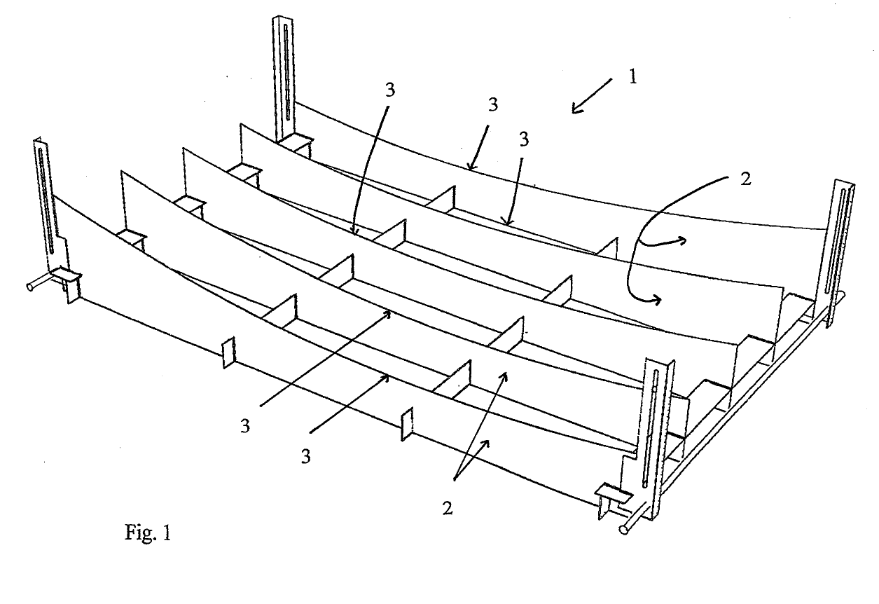

FIG. 1 shows that the primary supporting construction 1 is formed by steel partitions 2 whose upper sides define bearing lines 3 that all lie in an imaginary plane exhibiting the predetermined desired double-curved shape. To this end each of the separate partitions 2 is provided with a single-curved top side 3, derived from the desired double curve created by all the partitions 2 together. Alternatively it is also possible to embody this primary supporting construction 1 to be adjustable for obtaining the bearing lines 3 that correspond to the desired double-curved shape. It is then also possible—as opposed to what is shown in the figures—to begin with a flat starting position of the primary supporting construction 1 with the same supporting the secondary supporting construction with the (glass) panel and, after the panel is sufficiently heated, to adjust the primary supporting construction so as to obtain the above-mentioned bearing lines 3.

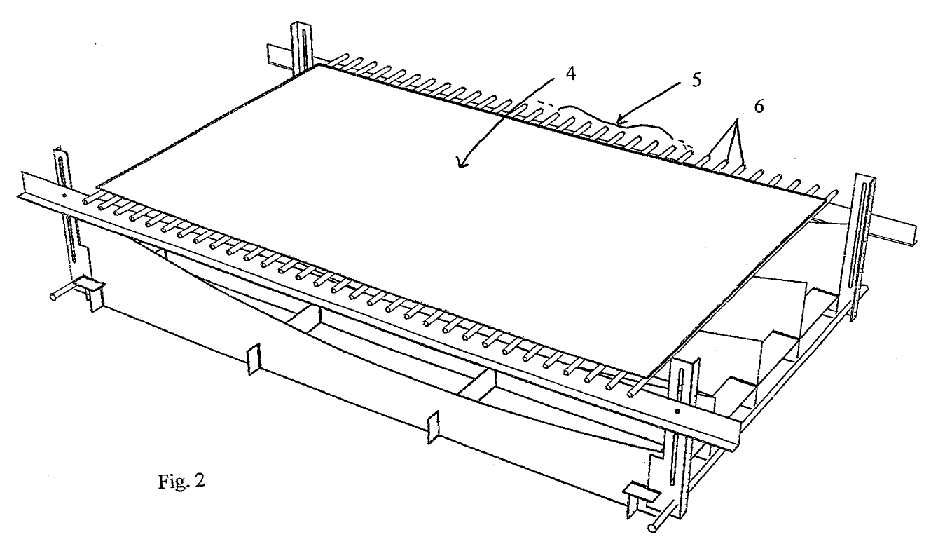

In FIG. 2 a flat glass plate 4 rests on a likewise still flat mat 5 formed by the flexible rods 6 of a secondary supporting construction 5 located above the primary supporting construction 1. In this position the glass plate 4 can be heated and, when the glass plate 4 has become sufficiently bendable, the secondary supporting construction 5 may be lowered such that the rods 6 defining bearing lines for the glass plate 4, come to rest on the orthogonally oriented bearing lines 3 that are determined by the partitions 2 of the primary supporting construction 1. It will be obvious that instead of lowering the rods 6 with the glass plate 4 resting thereon, the primary supporting construction 1 may also be moved upward.

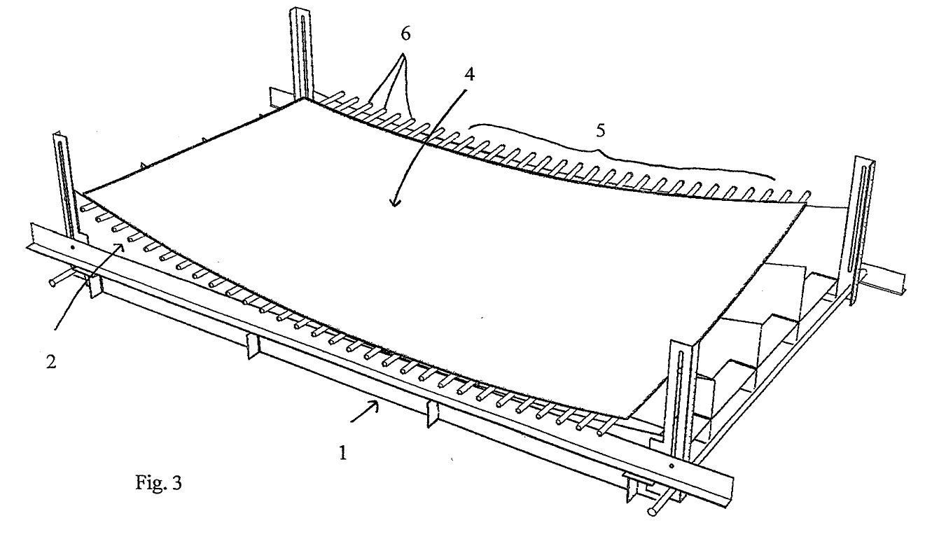

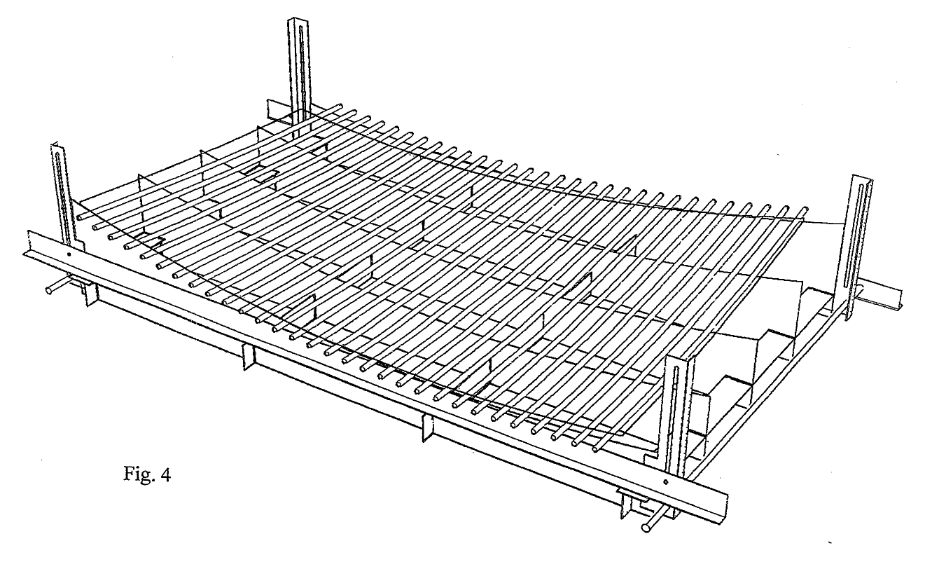

Deformation of the rods 6 of the secondary supporting construction 5 occurs subject to the distribution of gravitational forces exerted on the rods 6 of the secondary supporting construction 5 during heating of the glass panel 4. This distribution of gravitational force makes that, as show in FIG. 3 and even more clearly in FIG. 4, these rods 6 come to rest on all of the partitions 2 of the primary supporting construction 1. The rods 6 of the secondary supporting construction 5 will over their length assume an orientation that lies almost completely in the plane of the predetermined double-curved shape embodied in the primary supporting construction 1. Accordingly, the glass panel 4 also substantially assumes this desired double-curved shape.

If it is desirable to optimize the accuracy of the double-curved shape of the panel 4, it is possible to increase the density of the bearing lines of the primary 1 and secondary 5 supporting construction.

Within the scope of the invention it is also possible for a tertiary supporting construction to be added to the apparatus or to be used with the method, respectively, which cooperates with the secondary supporting construction in a manner corresponding to the one explained above regarding the primary and the secondary supporting construction.

What is claimed is:

1. A method for forming a double-curved panel from a flat panel, which comprises processing a plastically deformable flat panel or rendering the flat panel plastically deformable to enable it to mould itself to a predetermined shape, wherein the shape is obtained by a primary supporting construction cooperating with a secondary supporting construction, wherein the primary supporting construction may or may not be adjustable to an invariant position that determines the shape, and the secondary supporting construction is adjustable between a starting position in which it supports the flat panel, and a finishing position in which the secondary supporting construction supports the double-curved panel, while said supporting construction rests on the primary supporting construction and is shaped in accordance with the shape of the primary supporting construction, wherein the adjustment from the starting position to the finishing position occurs at least subject to the distribution of the gravitational force exerted on the secondary supporting construction by the panel while this is plastically deformable.

2. A method according to claim 1, wherein the primary supporting construction and the secondary supporting construction substantially define cross-wise intersecting supporting lines.

3. A method according to claim 1, wherein the primary supporting construction may be provided with a plurality of additional construction elements, which at the upper side define a plurality of first supporting lines, and that all of these first supporting lines determined by the construction elements lie in an imaginary plane having the predetermined shape.

4. A method according to claim 1, wherein the secondary supporting construction is a mat comprising a plurality of flexible rods disposed next to each other.

5. A method according to claim 4, wherein the plurality of flexible rods are placed cross-wise on the plurality of first bearing lines of the construction elements of the primary supporting construction, thus forming a plurality of second bearing lines, which serve to support the panel.

6. An apparatus for forming a double-curved panel from a flat panel, wherein the same comprises a primary supporting construction that may or may not be adjustable to a time-invariable form that corresponds to a desirable double curve of the panel, as well as a secondary supporting construction that is designed to rest on the primary supporting construction and, subject to at least a distribution of gravitational force from a panel resting on the secondary supporting construction, is deformable into a shape that corresponds to the time-invariable shape of the primary supporting construction.

7. An apparatus according to claim 6, wherein the primary supporting construction is provided with a plurality of additional construction elements, which at the upper side define a plurality of first supporting lines, and that all of these first supporting lines determined by the construction elements lie in an imaginary plane having the predetermined shape.

8. An apparatus according to claim 6, wherein the secondary supporting construction is a mat comprised of a plurality of flexible rods disposed next to each other.

9. An apparatus according to claim 8, wherein the plurality of flexible rods are placed cross-wise on the plurality of first bearing lines of the construction elements of the primary supporting construction, which rods thus form a plurality of second bearing lines, which serve to support the panel.
